(19) United States
(12) Patent Application Publication
(10) Pub. No.: US 2004/0245411 A1
(43) Pub. Date: Dec. 9, 2004

(54) Modular cable support system

(76) Inventors: Kevin Patrick Phelan, Atmore, AL (US); Conrad Wakefield Ponder, Birmingham, AL (US)

Correspondence Address: Mr. Kevin P. Phelan, Brewton Industrial Park, 104 First Avenue, Brewton, AL, 36426, US

(21) Appl. No.: 10/831,728

(22) Filed: Apr. 26, 2004

Related U.S. Application Data
(60) Provisional application No. 60/468,688, filed on May 8, 2003.

(51) Int. Cl. F16L 3/00

(52) U.S. Cl. 248/49

(57) ABSTRACT

A modular cable support system in a modified “J” or a modified “G” shape which forms a continuous pathway and bearing surface for the distribution of voice and data cables. The design of which allows shorter lengths to be cut off and used for cable hook applications. Longitudinal wires are welded perpendicularly to a multitude of cross wires forming a universal fastening aperture at the top and the bottom portion of the vertical member. Attachment to walls, ceilings, and under raised computer room floors are accomplished by using the universal fastening aperture eliminating the need for additional mounting accessories or supports.

### CROSS REFERENCE TO RELATED APPLICATIONS

A provisional patent application was filed on May 8, 2003 by Kevin Patrick Phelan, Atmore, Ala., and Conrad Wakefield Ponder, Birmingham, Ala. Title is MODULAR CABLE SUPPORT SYSTEM. Application number is 60/468,688.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

This invention relates to the field of cable management systems which provide a structured supporting pathway for one or more telecommunication, computer, electrical, or video cables. Cable management systems are attached to building walls, ceiling beams, or raised floor structures. Cable management systems are generally comprised of:

1) Cable tray which forms a continuous path for the distribution of cables. Cable tray maintains a continuous cable bearing surface by changing horizontal and vertical directions which are achieved by cutting, bending, and applying hardware clamping devices or other field fabricated fittings to secure the change in direction. The cable bearing surface is provided by wire cross members welded at evenly spaced intervals to the longitudinal members. Supporting accessories are required to mount cable tray to walls, ceilings, or underfloor applications.

2) Cable hooks or J-hooks which individually provide a support for cable and are installed at intervals along the length of the cable run. Cable hooks are generally made of a solid stamped metal piece or extruded aluminum in the form of a “J” which has the horizontal cable bearing surface at the bottom section of the “J”. Cable hooks do not provide a continuous support structure to prevent cable sag; therefore, they must be installed at frequent intervals.

### REFERENCES CITED

US patent Documents

| | | | |
|---|---|---|---|
| 5,531,410 | 07/1996 | Simon (Mavil) | 248/49 |
| 5,740,994 | 04/1998 | Laughlin (Erico Intl) | 248/68.1 |
| 5,893,539 | 04/1999 | Tran, et al. (NCR) | 248/68.1 |
| 5,927,658 | 07/1999 | Gester (Zurecon AG) | 248/49 |
| 5,961,081 | 10/1999 | Rinderer (Sigma-Aldrich) | 248/68.1 |
| 6,019,323 | 02/2000 | Jette | 248/49 |
| 6,138,961 | 10/2000 | Zweig (Metal Deploye) | 248/68.1 |
| 6,361,000 | 03/2002 | Jette | 248/68.1 |

### SUMMARY OF THE INVENTION

The invention comprises a series of wall or ceiling mounted J-shaped supports that hold and maintain cables in a single pathway mounted to building walls, ceiling beams or raised floor structures. Specifically, the modular cable support system comprises a plurality of support members constructed from lengths of wire stock welded to J-shaped, or modified J-shaped (having an upper stem portion folded over 900 to essentially a G shape), wire cross members. More particularly, four or five longitudinal lengths of wire are welded perpendicularly to a series of spaced J or G hooks to form one section of the pathway wherein first and second lengths are closely spaced at the upper stem ends resulting in a universal fastening aperture while the third and fourth lengths are welded to a lower stem, on some sizes resulting in a second universal fastening aperture, and the final longitudinal wire ending at the hook end of each of the hooks. The lower portion of each section constitutes a cable holding tray or pathway. Any section can be cut to shorter pieces or bent depending on the desired direction of the cable pathway.

The cable tray application is transitioned in the horizontal and vertical directions by cutting the longitudinal wires and achieving the desired horizontal and vertical directions eliminating the need for field fabricated fittings. The invention may also be transitioned by field fabrication in the horizontal and vertical directions by cutting longitudinal and cross wire sections, bending to achieve the desired direction and securing with hardware clamping devices. Attachment to wall structures is accomplished by using the universal fastening aperture formed by the top two longitudinal wires that run along the entire support section length and fastening with screw and washer hardware. Attachment to underfloor supports is accomplished by using the universal fastening aperture formed by the top two longitudinal wires that run along the entire section length and fastening with U-bolt, washer and hex head nut hardware.

Attachment to ceiling beams via threaded rod is accomplished by inserting the threaded rod through the universal fastening aperture formed by the two longitudinal wires along the top horizontal surface of the tray that is formed for threaded rod mount and secured with washers and hex nuts. This eliminates the supporting accessories required to mount cable trays. The bearing surface is defined by crosswire members spaced at the distances so as to provide an appropriate bearing surface for cables along the continuous length of the invention thus providing a continuous support structure which prevents the cables from sagging and protects cables from possible damage.

The cable hook application can be fabricated in the field by cutting the longitudinal members to form the cable hook of a desired length and bearing surface. The cable hook may be mounted to the wall, ceiling beams through a threaded rod, and to underfloor supports using the universal fastening aperture as described in the cable tray system above.

The ability to secure cable bundles in the cable tray or cable hook application is accomplished by using a cable tie affixed to the third and fourth longitudinal wire. This method secures the cable within the cable pathway yet does not directly wrap the cable bundle with a cable tie so as not to cause damage to the cables by too much pressure through a direct cable wrap.

### BRIEF DESCRIPTION OF DRAWINGS

For better understanding of the invention, reference is made to the following description of exemplary embodiments thereof, and to the accompanying drawing figures, wherein:

FIG. 1 is a perspective view of the modular cable support system wall mount cable tray application.

FIG. 2 is perspective view of the modular cable support system wall mount J-hook application.

FIG. 3 is a side view of the modular cable support system wall mount version.

FIG. 4 is an enlarged partial perspective view of the modular cable support system wall mount cable tray application.

FIG. 5 is a perspective view of the modular cable support system ceiling mount cable tray application.

FIG. 6 is a perspective view of the modular cable support system ceiling mount J-hook application.

FIG. 7 is a side view of the modular cable support system ceiling mount version.

FIG. 8 is an enlarged partial perspective view of the modular cable support system ceiling mount cable tray application.

FIG. 9 is a side view of the modular cable support system in the cable separation application

FIG. 10 is a side view of the cable support system mounted to the pedestal of a raised computer room floor.

### DETAILED DESCRIPTION OF PREFERRED EMBODIMENTS

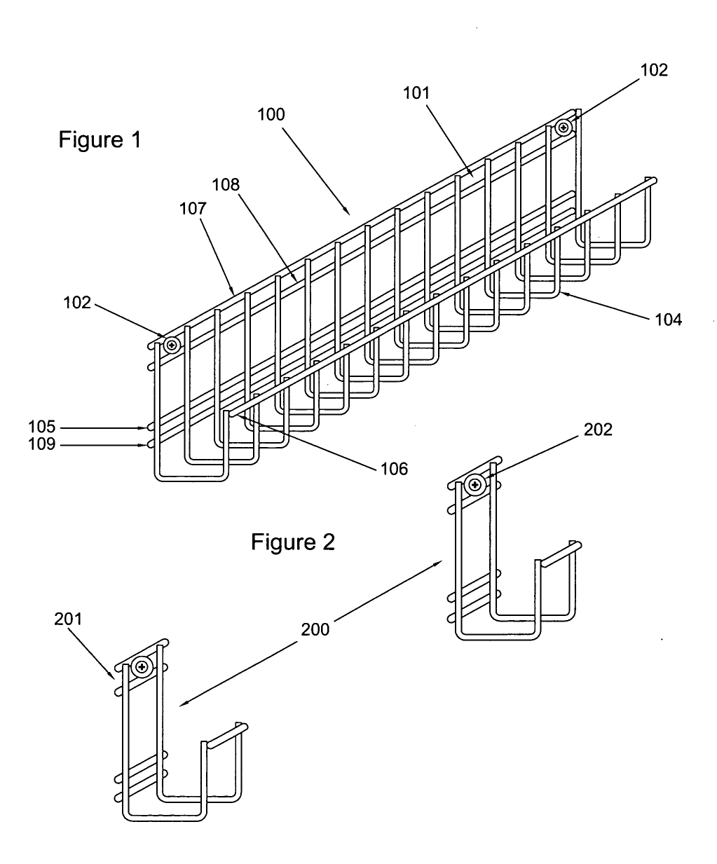

Referring to the drawings in detail and initially to FIG. 1, the presently disclosed modular cable support system 100 is shown in the wall mount cable tray application. The universal fastening aperture 101 is formed by the intersection of longitudinal wires 107 and 108 and cross wires 104. The universal fastening apertures are exemplified by 101 and are used when fastening hardware 102 attaches to either hardboard, concrete, or sheet rock walls.

Referring to FIG. 2 and FIG. 4, the presently disclosed modular cable support system application is shown in the wall mount J-hook application 200. The J-hooks are constructed by cutting the wall mount cable tray 100 longitudinal wires 105, 106, 107, 108, and 109 to form a J-Hook 200 for supporting branch runs of cable. Attachment to wall uses fastening hardware 202 thru the universal fastening aperture 201.

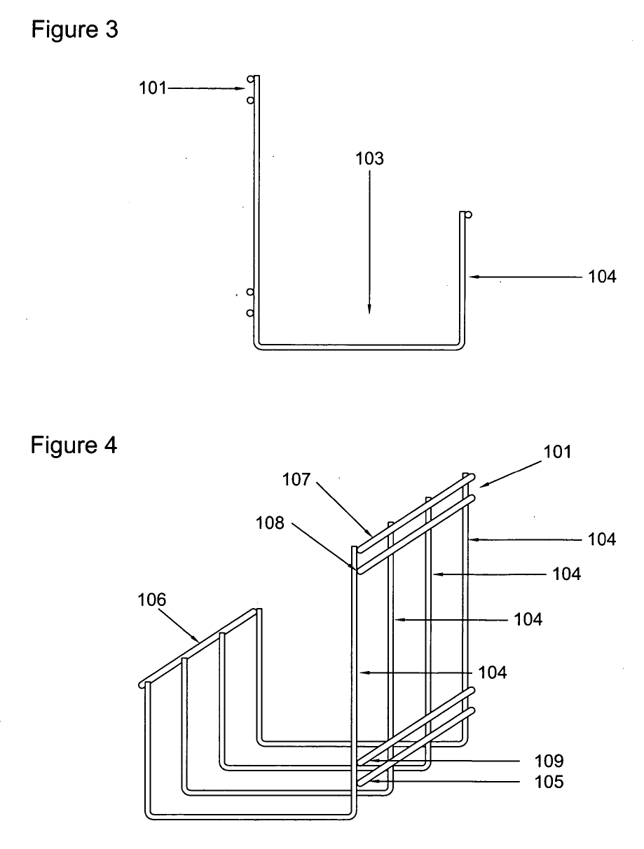

Referring to FIG. 3, cables are received thru the opening 103 and placed on the bearing surface formed by horizontal cross wires 104. Referring to FIG. 4, the longitudinal wires 105, 106, 107, 108, 109 welded to the plurality of cross wires 104 form the bearing surface. Intersection of cross wires 104 and longitudinal wires 107 and 108 form the universal fastening aperture along the length of the section so that mounting can be accomplished at any place along the length of the cable tray. Intersection of cross wires 104 and longitudinal wires 105 and 109 form a second universal fastening aperture for applications requiring different spacing on the mounting surface or additional hardware.

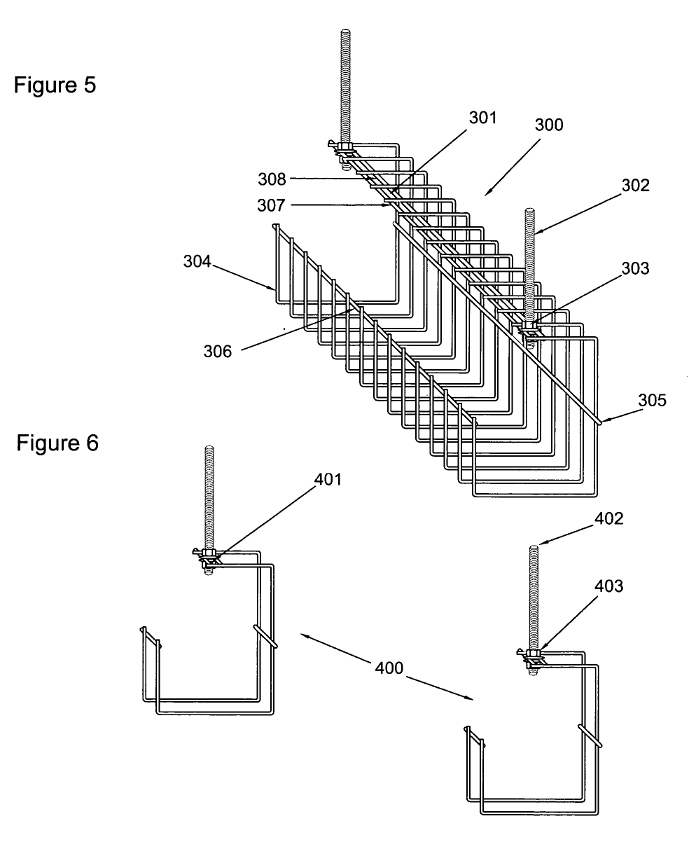

Referring to FIG. 5, an alternative embodiment of presently disclosed modular cable support system 300 is shown in the ceiling mount cable tray application using an all threaded rod. The universal fastening aperture 301 is formed by the intersection of longitudinal wires 307 and 308 and cross wires 304. The universal fastening apertures are exemplified by 301 and are used when fastening washers and hex nuts 303 are attached to an all threaded rod 302.

Referring to FIG. 6 and FIG. 8, the presently disclosed modular cable support system application is shown in the ceiling mount J-hook application 400. The J-hooks are constructed by cutting the ceiling mount cable tray 300 longitudinal wires 305, 306, 307, and 308 to form a J-Hook 400 for supporting branch runs of cable. Attachment to an all threaded rod 402 uses fastening hardware 403 thru the universal fastening aperture 401.

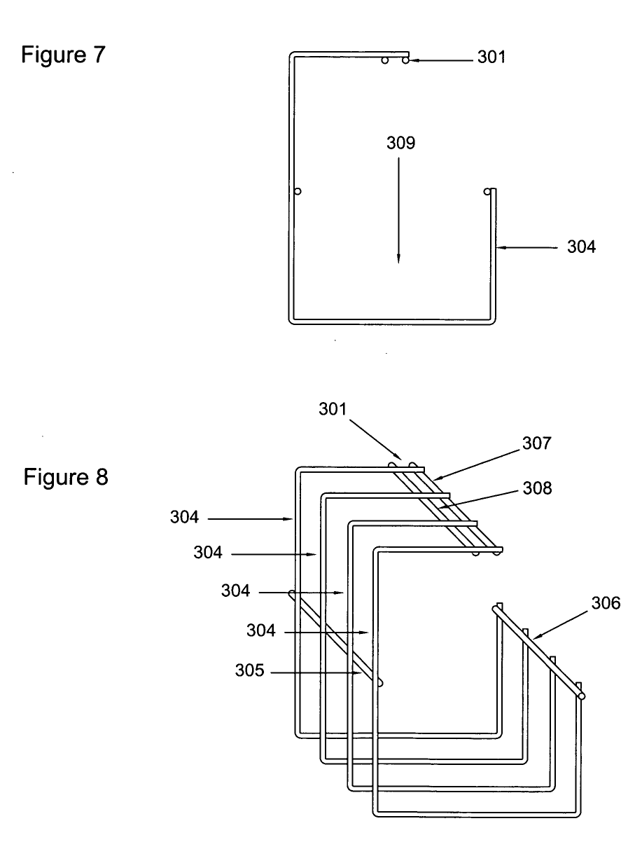

Referring to FIG. 7, cables are received thru the opening 309 and placed on the bearing surface formed by horizontal cross wires 304. Referring to FIG. 8, the longitudinal wires 305, 306, 307, 308 welded to the plurality of cross wires 304 form the bearing surface. Intersection of cross wires 304 and longitudinal wires 307 and 308 form the universal fastening aperture along the length of the section so that mounting can be accomplished at any place along the length of the cable tray.

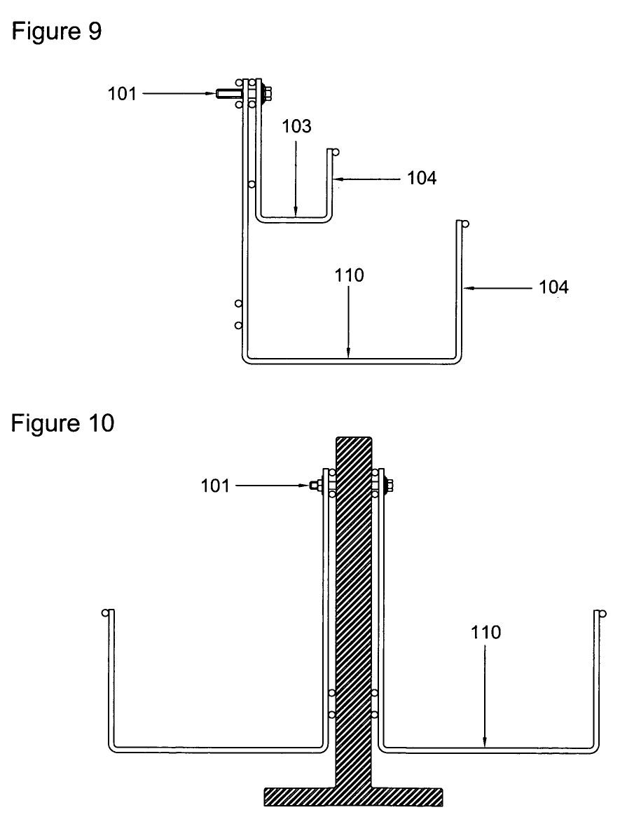

Referring to FIG. 9, an alternative embodiment of presently disclosed modular cable support system 100 is shown in the cable separation application. Fiber optic cables are received through the opening 103 and placed on the bearing surface formed by horizontal cross wires 104. Two separate and distinct pathways are created 103 for fiber optic cable and 110 for copper cable but mounted as one through the universal fastening aperture. Referring to FIG. 10, an alternative embodiment of presently disclosed modular cable support system 100 is shown in an application under a raised computer room floor. The universal fastening aperture 101 created by the intersection of cross wires 104 and longitudinal wires 107 and 108 allows the modular cable support system to be mounted to the existing raised floor pedestal without removing neither the pedestal nor the addition of any extra hardware.

I claim:

1) A modular cable support system invention which comprises:
a) Support sections with which the cable pathway is defined by longitudinal wires welded to cross wire members throughout the length of the cable tray support section.
b) Four or five longitudinal wires provide the structural support along the entire length of the support section.
c) Cross wire members welded to the longitudinal members to provide the bearing surface for cables placed within the section.
d) Support sections are attached together to form continuous runs of a cable support system.

2) A modular cable support system as described in claim 1 that uses two of the longitudinal wires to form a universal fastening aperture throughout the section for wall, ceiling beam, or underfloor mounting application. The universal fastening aperture provides the capability for attachment and mounting along the entire length of the support section.
a) Fastening hardware for wall mounting is a screw/bolt and washer hardware or other commercially available driver systems.
b) Ceiling beam mount application is accomplished by inserting a threaded rod through the universal fastening aperture and securing with washer and hex head nut hardware.
c) Underfloor mounting is secured by U-bolt, washer, and hex head nut hardware.

3) A modular cable support system as described in claim 1 whereas the cable path can be modified in the horizontal and vertical directions by cutting the longitudinal wires and achieving the desired horizontal and vertical directions without the use of field fabricated fittings. The cable path may also be directed in the horizontal and vertical planes by cutting the designated longitudinal and cross wire members, bending, and securing with common hardware items to effect the desired change in the vertical and horizontal plane in a matter similar to current wire cable tray systems.

4) A modular cable support system that can be field fabricated to configure a cable hook or J-hook by cutting the longitudinal wires to form the desired length for the cable hook or J-hook to eliminate cable sag and possible damage to the cable. Labor savings are derived by customizing the length of the J-hook load bearing surface so as to provide the appropriate cable support without the necessity for multiple J-hook installations. The top two longitudinal wires form the universal fastening aperture when configured as a cable hook or J-hook.

5) A modular cable support system as described in claim 1 that uses a cable tie around the 3rd and 4th longitudinal wires to secure cables within the cable path of the cable tray or and the 1st and 4th longitudinal wires to secure cables within the cable path of the cable hook application.

6) A modular cable support system described in claim 1 that uses the 3rd wire to provide:
a) Flush mounting to a wall or underfloor support surface in conjunction with the 1st and 2nd longitudinal wires.
b) A member to reduce deflection of the cable support system when cables are placed on the horizontal load bearing surface.

7) A modular cable support system described in claim 1 that saves material costs by using the universal fastening aperture thereby not requiring wall mounting brackets, center hung support brackets, trapeze hanger supports, and floor support brackets generally found in cable tray system installations.

8) A modular cable support system described in claim 1 that provides material and labor savings by providing a cable support structure that can be field configured as either a continuous cable tray system or customized to form J-hooks with variable load bearing surfaces to meet cable management requirements.

9) A modular cable support system described in claim 1 that uses two of the longitudinal wires to form a universal fastening aperture throughout the section for mounting one modular cable support system within another modular cable support system. Mounting one modular cable support system within another modular cable support system creates two separate and distinct pathways for cables. Fiber optic cables being separated and held above copper cables without the need for additional support accessories.

10) A modular cable support system described in claim 1 that uses two of the longitudinal wires to form a universal fastening aperture throughout the section which allows the modular cable support system to be positioned and fixed under a raised computer room floor being attached to the existing raised floor support pedestal without the need for additional support accessories nor the removal of the floor support pedestal.
